(19) United States
(12) Patent Application Publication
(10) Pub. No.: US 2009/0099921 A1
(43) Pub. Date: Apr. 16, 2009

(54) SYSTEM AND METHOD FOR ADVERTISING AND DELIVERIG MEDIA IN CONJUNCTION WITH AN ELECTRONIC MEDICAL RECORDS MANAGEMENT, IMAGING AND SHARING SYSTEM

(76) Inventors: Matias Klein, Blue Bell, PA (US); Julian Klein, Huntingdon Valley, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/211,476

(22) Filed: Sep. 16, 2008

Related U.S. Application Data
(60) Provisional application No. 60/972,982, filed on Sep. 17, 2007.

(51) Int. Cl. G06Q 30/00; G06Q 50/00

(52) U.S. Cl. 705/14; 705/2

(57) ABSTRACT

A method for displaying and distributing provided data including media and advertisements to a user of an electronic system for the management of medical documents includes establishing and operating a web-based application for viewing, storing, managing and sharing the medical documents in electronic format by an operator, providing the provided data, and selecting at least portions of the provided data based upon sponsorship by a sponsoring entity to provide selected data, the provided data being correlated to stored profile attributes of the user. The method also includes displaying and distributing the selected data, and the sponsoring entity providing compensation to the operator.

### CROSS-REFERENCE TO RELATED APPLICATION

This application claims priority from Provisional Application No. 60/972,982 filed on Sep. 17, 2007, entitled SYSTEM AND METHOD FOR ADVERTISING IN CONJUNCTION WITH AN ELECTRONIC MEDICAL RECORDS MANAGEMENT, IMAGING AND SHARING SYSTEM, which application is assigned to the same assignee as this application and whose disclosure is incorporated by reference herein.

### BACKGROUND OF THE INVENTION

1. Field of Invention

This invention relates generally to the internet and, more specifically, to a method and system whereby advertising information can be presented to users in the form of advertisement placements or website branding in conjunction with an electronic medical document management system.

2. Background of the Invention

Such medical document management systems are known in the field. For example, we point to and hereby incorporate by reference, the earlier, co-pending application of applicant's assignee, U.S. patent application Ser. No. 11/438,380, which discloses such a system. The existing systems in the field, however, do not provide the method of advertising in conjunction with such system as described herein.

### BRIEF SUMMARY OF THE INVENTION

A method for displaying and distributing provided data including media and advertisements to a user of an electronic system for the management of medical documents includes establishing and operating a web-based application for viewing, storing, managing and sharing the medical documentation in electronic format by an operator, providing the provided data, and selecting at least portions of the provided data based upon sponsorship by a sponsoring entity to provide selected data, the provided data being correlated to stored profile attributes of the user. The method also includes displaying and distributing the selected data, and the sponsoring entity providing compensation to the operator.

A method for displaying provided data, including media to be displayed and/or delivered, advertising to be displayed and/or delivered, or any other kind of data, to a user of an electronic medical document management system, the method including establishing and operating a web-based application for viewing, storing, managing and sharing medical documentation and related documents in electronic format by an operator; providing advertisements including at least one electronic medium; selecting the advertisements based upon sponsorship by sponsoring entities, correlated to stored profile attributes of a user; the sponsoring entities providing compensation to the operator.

In accordance with another aspect of this invention, a system and method are provided for permitting targeted media delivery and branded advertising in conjunction with the storage, presentation and sharing of electronic medical records and related documents, and through related brochures. The method includes: (a) presenting advertising in various media from sponsoring entities to users of the internet-based system; (b) secure electronic filing, management and sharing of electronic medical records and electronic documents related to medical treatment amongst caregivers, patients and other appropriate parties; (c) the ability to rapidly review electronic medical records and related electronic documents in a manner similar to flipping through a paper file.

### DESCRIPTION OF THE ATTACHED FIGURES

FIG. 1 shows a schematic representation of an embodiment of the system and method for displaying and distributing provided data of the present invention.

FIG. 2 shows a schematic representation of a core database model suitable for use with the system for displaying and distributing provided data of FIG. 1.

FIG. 3 shows a schematic representation of an embodiment of a system brochure suitable for use with the system for displaying and distributing provided data of FIG. 1.

FIG. 4 shows a schematic representation of an embodiment of a gift card suitable for use with the system for displaying and distributing provided data of FIG. 1.

FIG. 5 shows a flow chart representation of an embodiment of a registration or opt-in procedure suitable for use with the system for displaying and distributing provided data of FIG. 1.

FIG. 6 shows a screen shot representation of a login screen suitable for use with the system for displaying and distributing provided data of FIG. 1.

FIG. 7 shows a screen shot representation of a clinician home page suitable for use with the system for displaying and distributing provided data of FIG. 1.

FIG. 8 shows a screen shot representation of a scan interface suitable for use with the system for displaying and distributing provided data of FIG. 1.

FIG. 9 shows a screen shot representation of a search interface suitable for use with the system for displaying and distributing provided data of FIG. 1.

FIG. 10 shows a screen shot representation of a flip view interface suitable for use with the system for displaying and distributing provided data of FIG. 1.

FIG. 11 shows a screen shot representation of a document and media share interface suitable for use with the system for displaying and distributing provided data of FIG. 1.

FIG. 12 shows a flow chart representation of a share procedure suitable for use with the system for displaying and distributing provided data of FIG. 1.

FIG. 13 shows a screen shot representation of an address book suitable for use with the system for displaying and distributing provided data of FIG. 1.

FIG. 14 shows a screen shot representation of a patient home page suitable for use with the system for displaying and distributing provided data of FIG. 1.

FIG. 15 shows a screen shot representation of a patient messages inbox suitable for use with the system for displaying and distributing provided data of FIG. 1.

FIG. 16 shows a screen shot representation of a patient document interface suitable for use with the system for displaying and distributing provided data of FIG. 1.

FIG. 17 shows a screen shot representation of a patient caregiver interface suitable for use with the system for displaying and distributing provided data of FIG. 1.

FIG. 18 shows a screen shot representation of a sponsor home interface suitable for use with the system for displaying and distributing provided data of FIG. 1.

### DETAILED DESCRIPTION OF THE INVENTION

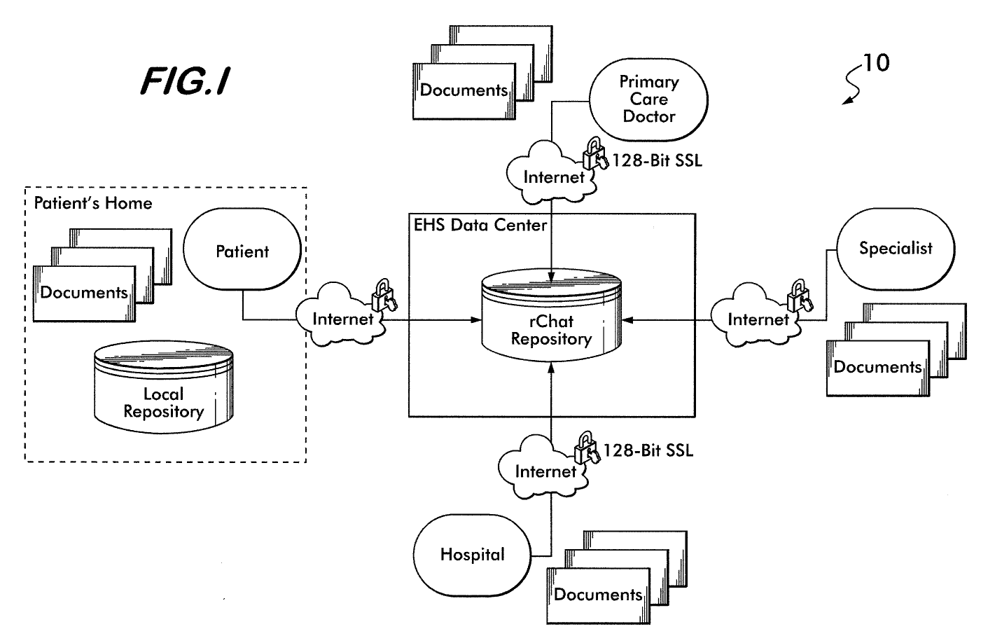

Referring now to FIG. 1, there is shown an overview of an embodiment of an internet based embodiment of the medical document advertising and media delivery system 10 of the present invention. The medical document advertising and media delivery system 10 allows for the management of electronic medical records and the management of electronic medical documents by a user of the sponsor-branded system 10. The medical document advertising and media delivery system 10 also allows for the presentation of related advertising messages and other provided data through various media to a user of the system 10. The medical document advertising and media delivery system 10 can be accessed by a user having a unique user identification. The user may be a clinician, patient, parent or other person. The clinicians using the system 10 can be physicians, nurses, alternative health care providers or any other type of caregivers. In a preferred embodiment of the medical document advertising and media delivery system 10 all users can be part of the same network and share the same central repository. The medical document advertising and media delivery system 10 can be available in online and offline modes so that connectivity to the internet does not need to be continuous.

In a preferred embodiment of the medical document advertising and media delivery system 10 patients can have the option of storing their documents on their home personal computer. The system 10 can allow them to share their records on the network so that their doctors and other clinicians can request access to the documents on demand. The patients can control access to their records, but clinicians in the network can be permitted to see that a particular patient's files exist in certain locations, and the clinicians may selectively request access to the documents. If desired, the patients can then authorize the clinicians to view the selected documents.

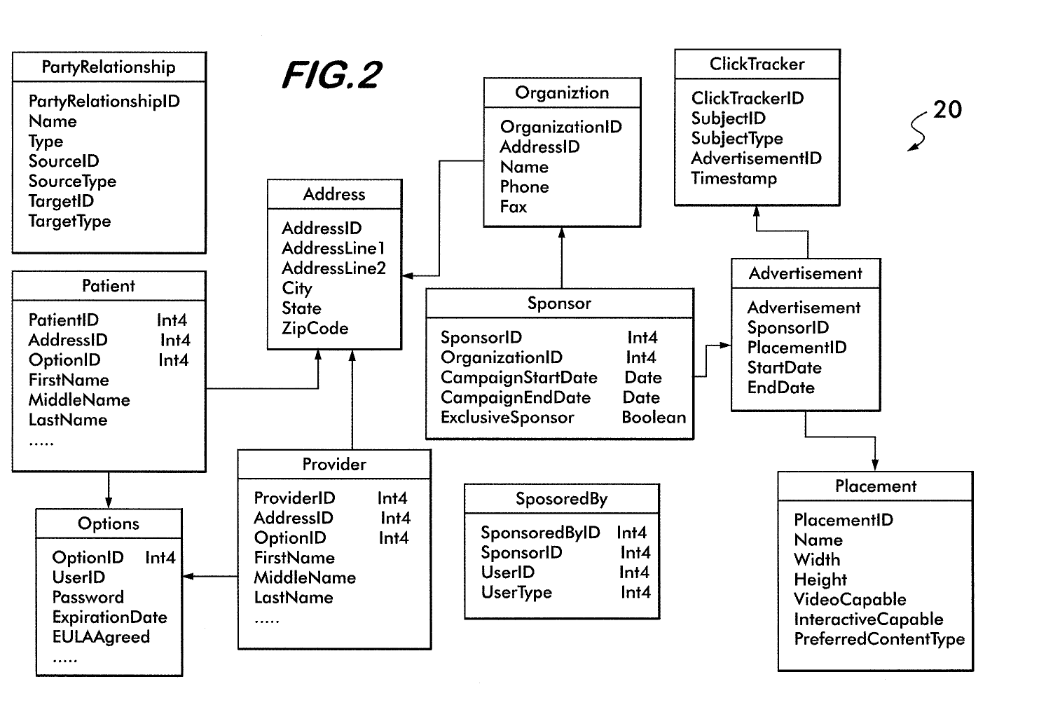

Referring now to FIG. 2, there is shown an embodiment of a database model 20 for storing and retrieving the core data associated with the operations of the medical document advertising and media delivery system 10. While the database model 20 as shown is believed to be especially well suited for supporting the operations of the medical document advertising and media delivery system 10, it will be understood that those skilled in the art may use any other any method or system for storing and retrieving data as needed. Furthermore, is will be understood by those skilled in the art that the medical document advertising and media delivery system 10 can also be referred to using other titles such as the medical record advertising system 10, the medical media delivery system 10 and the medical record advertising system 10, etc.

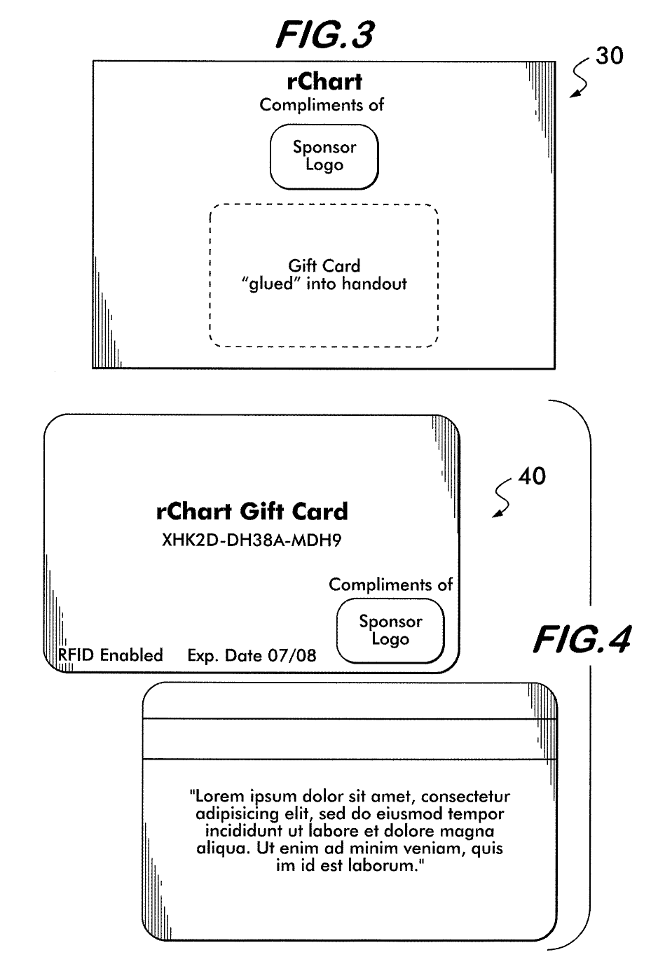

Referring now to FIG. 3, there is shown a schematic representation of an embodiment of the system brochure 30. A user of the medical document advertising and media delivery system 10 can obtain the unique user identification and other information regarding the system 10 through the system brochure 30, which can contain printed information including the world wide web address of the medical document advertising and media delivery system 10. In a preferred embodiment the system brochure 30 can have a compelling shape and can include a fold out section. It may be the size of a CD jewel case and can be easily distributed at trade shows, etc. or mailed to potential users. It can demonstrate the ease of use of the system 10 and can succinctly demonstrate how to sigh up and begin using the system 10.

Referring now to FIG. 4, there is shown the gift card 40. In one preferred embodiment the system brochure 30 can contain the gift card 40. The user identification can be printed on the gift card 40. The gift card 40, similar to a credit card, can contain printed information such as text, graphical information and either a magnetic strip, RFID, both or any other information storage means. The user of the medical document advertising and media delivery system 10 may also receive the system brochure 30 and gift card 40 in electronic format via e-mail.

The graphical and printed information on the system brochure 30 and the gift card 40 may relate to a sponsoring entity whose logos, graphics, text, etc. are used to brand the brochure 30 and the gift card 40. Magnetic strip, RFID data and printed identification can link the gift card 40 to a unique identifier within the electronic database of the system 10. Additionally, the gift card 40 can use formats such as bluetooth, wifi, CDMA or any other type of format. As describe in more detail below, the user can enter an identifier from the gift card 40 into the login screen of the system 10 either by manual typing, swiping of the card 40 through a magnetic card reader. The user can also pass the card 40 through or past a device suitable for reading the RFID information of the card 40 in order to communicate the information to the system 10, or enter the information into the system 10 in any other manner. These methods of entering the identifier into the medical record advertising system 10 may be performed via the internet, at kiosks established in public locations, at clinicians' offices, hospitals or any other facility equipped with suitable readers.

The system brochure 30 may be distributed by clinicians or other individuals to patients or any other users. It may be distributed at trade shows, by direct mail, by email, from sponsors to customers and so forth. The activation code or membership identification number of the gift card 40 can allow tracking of a sponsoring organization that distributes the gift card 40, as well as allowing user to check-in and update their medical history, chart permissions, demographics etc.

Correlated to the unique identifier of the gift card 40, and stored within the database of the system 10, is the identity of a sponsoring entity. Based upon this correlation, the logo, advertising collateral and other multimedia content of the sponsoring entity can be used to brand the appearance of the system 10, for example the skin of the system 10, so that the user who logs in can view a website that corresponds visually to the brochure 30 and gift card's sponsor-specific design. A user who logs into the medical record advertising system 10 using an identifier that is not correlated with a sponsor or an identifier for which the sponsor has ceased its relationship with the operating entity can view a default branded website with the visual styling of the operating company. More than one sponsoring entity can be associated with a single user.

The medical record advertising system 10 can correlate the unique identifier of the user to a system role, which role will determine the type of information and functionality presented to that user upon accessing the system 10. System roles may include, but are not limited to, patient, clinician, sponsor and the like. Each system role may have corresponding functionality within the system 10 and the user can be directed to the appropriate home page after logging in.

For example, a user with the patient role logging into the medical record advertising system 10 can be presented with health-related content including news and advertisements. A patient can also be presented with an inbox, similar to an email inbox through which he or she may receive secure messages from other users including but not limited to correspondence from clinicians and requests for approval to allow one clinician to share patient information with another clinician while complying with all statutory requirements including HIPAA. As described in more detail below, patient users can also have access to the sections such as the following: (1) My Documents, in which the patient's electronic medical documents can be viewed and processed; and (2) My Caregivers, in which the patient's physicians and other clinicians and practitioners can be listed.

The medical record advertising system 10 can also allow patients to link the accounts of certain users including parents/children and patient/guardian. The patient user also has access to his or her personal health record (PHR) which contains the patient's complete medical history, including lab results, x-rays, allergies, problems, immunizations, and any other data related to clinical episodes. The system 10 can allow the patient users to manage their personal health record and related electronic documents. The system 10 can provide the ability for the user to import or export electronic documents, either by scanning, uploading or similar functions, and to store them on the system 10. The patient can also control access to his or her personal health record and related electronic documents, and may grant or restrict access by others to his or her record.

A user with the clinician role can have access to an inbox similar to that described in the patient section, above. The clinician inbox allows the clinician to receive and send secure messages, request access to medical files, approve the sending of documents to him, and to receive medical files. The clinician inbox can also be used for general purpose secure messaging between physicians, nurses, staff members, and patients. Clinician users can also have access to a documents section, which includes digital files that may be uploaded, downloaded, sent to other users, searched, filed and entered by scanning. The accessible files, as well as the other types of files within the system 10, can be any known format. For example, the files can be txt, pdf, work, xls, wav, avi or mpg.

Similarly, any other customized views may be provided for users with other roles such as sponsor, insurer, etc. For example, a sponsor can be given access to tools within the medical record advertising system 10 for statistical reporting. The statistical reporting tool can allow analysis of the effectiveness of the sponsor's ads, both in total and geographically. Each user can be automatically directed to and shown the view appropriate to his or her role within the system 10 based upon the correlation between his or her unique identifier and role.

A first-time user of the medical record advertising system 10 can be required to register his or her user identification as described in more detail below, and to accept an end user license agreement for the system's use. This process can entail entering the unique identifier from the gift card 40 and providing required information. This information includes, but is not limited to, entering a user name and password, submission of demographic information by patient users, selection of providers by patient users and selection of colleagues and submission of practice information by practitioners. New users may also opt in or out of the receipt of marketing messages from the system 10, as described in more detail below. Additionally, it is possible for a user of the system 10 to change items such a user ID, a password, an image, a specialty, a medical school, an employer, a resume or a list of publications. In a preferred embodiment a settings screen may be displayed to a user to assist in making these changes.

The medical record advertising system 10 can also allow users to electronically file documents. This filing may be done by uploading electronic files or scanning documents. The upload functionality of the system 10 allows the user to search for the appropriate chart under which the document should be filed, upload the file to that chart and tag the file with identifying meta data. The upload function may be accomplished by dragging and dropping files directly into the system 10, or standard browse and upload methods. Any type of file may be stored in the system 10, but files that are not textual or graphical may not be sent to the system's fax gateway and may only be shared electronically. The scanning function allows the user to locate the file and then enter new documents into it by placing them on a scanner and causing the system 10 to import the scanned image. This scanning process can also allow users to rotate, crop and tag documents and to adjust the brightness and contrast of the scanned image. Users may also electronically write on the scanned document using input devices that mimic physical handwriting. The scanned document, including any modifications as just described is then saved into the medical record.

The system 10 allows the user to rapidly review filed documents in a method that mimics physical paper review, or flipping through pages. This method is optionally coupled with the use of finger gestures using suitable digital input devices such as a touch-screen or tablet PC. In the absence of such capability, the system's flip view may be controlled using a mouse, stylus or other standard input device. System 10 controls in this mode include on-screen buttons to move between documents and document thumbnail images for quick selection of the desired document. The flip view screen includes a community feedback area that allows clinicians and patients to collaborate on information in the patient's record and see comments on particular documents left by other users.

The medical record advertising system 10 can include a sharing wizard in order to manage the sharing of documents and health records amongst multiple users. The sharing wizard is a workflow system and rules engine that can be initiated when a user chooses to send a document or requests a document from another user. This sharing wizard is tied to the inbox functionality described above and helps streamline the document sharing process. For instance, when a clinician wishes to send a patient's health record to a consulting physician, such as a specialist, the sharing wizard can manage the process of seeking and receiving approval for this action from the patient and then delivering the document or documents to the consulting physician. This process is linked to the system inbox of each user involved in the transaction and is optionally coupled with a fax gateway for providing documents to parties not registered with the medical record advertising system 10. This sharing of documents may be applied to either individual documents or entire health records.

In one preferred embodiment of the invention the brochure 30 can be a 2-3 page handout intended for clinicians and/or patients or any other potential users of the system 10. One purpose of the system brochure 30 can be to succinctly explain what the system 10 is. In one embodiment the system 10 can be referred to as rChart. The structure of the brochure 30 should convey that rChart is as easy as 1-2-3. The handout brochure 30 can have the sponsor's logos and colors on it. The handout can have the gift card 40 glued inside it. A set of any number of handouts can be printed by the operator of the medical document advertising and media delivery system 10 for the sponsor. The sponsor can then distribute the handouts via their sales representatives, who will then in turn gift them to clinicians and/or patients when they visit the clinicians in their office, at trade shows, etc., or any other method of distribution desired.

The gift card 40 can be a marketing asset. The psychology of the gift card 40 can be to make clinicians and patients feel they are receiving something of value when they are given the gift card 40 by a sales representative. The gift card 40 can have the sponsor's logo on it and can also have a member ID number encoded in it (for example, either in the magnetic strip or with RFID). The member ID number can be stored in a database managed by the operator of the medical record advertising system 10 which can uniquely identify the member, the member's subscription information, and the member's sponsor. The recipient of the gift card 40 (clinician or patient) can go to a secure internet site to activate their subscription by entering their membership ID. Ultimately, the gift card 40 can be used, for example, in locations that have an rChart kiosk for rapid check-in to an office.

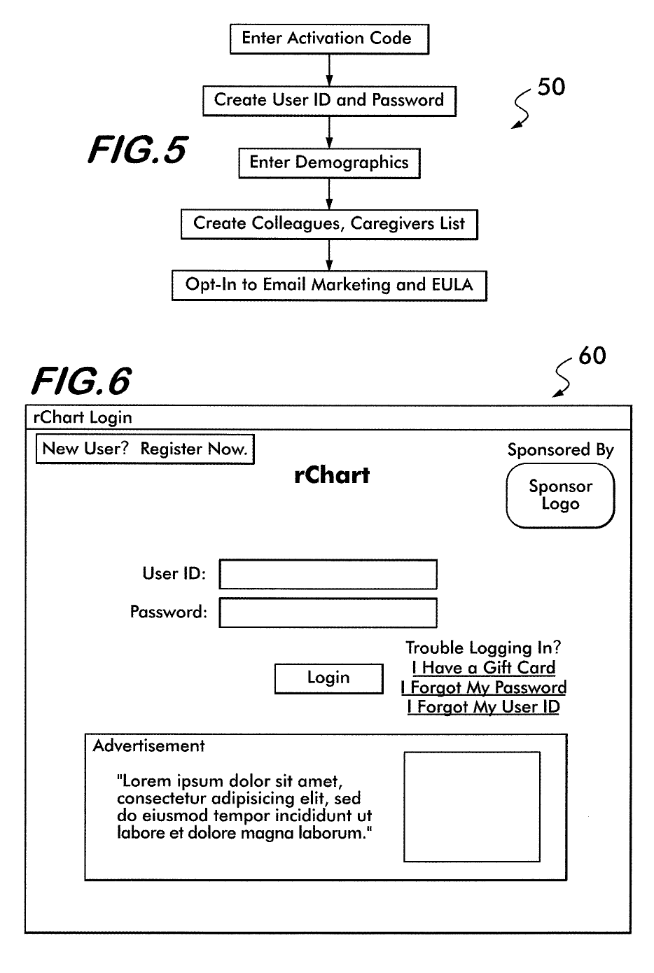

Referring now to FIG. 5, there is shown an embodiment of an opt-in procedure 50. The opt-in procedure 50 can be used for registration of a user in the medical record advertising system 10. Upon receiving a gift card 40, clinicians and patients can proceed to the rChart website where they can register to use the rChart web application using opt-in procedure 50. The user can enter the activation code provided in their gift card 40, select a user ID and password, enter their demographic details, create a list of their favorite colleagues (if clinician) or caregivers (if patient), and then opt-in to receive advertisements (accept EULA).

Referring now to FIG. 6, there is shown the login screen 60. A login screen such as the login screen 60 can be used when a user of the medical document advertising and media delivery system 10 enters the secure web application using their unique credentials. Upon login, the entire application's skin can adjust to the sponsor's look-and-feel based on whichever sponsor gifted the subscription to the user. Depending on whether the user is a clinician or a patient, they can be redirected to a clinician home page or a patient home page, respectively, as described in more detail below.

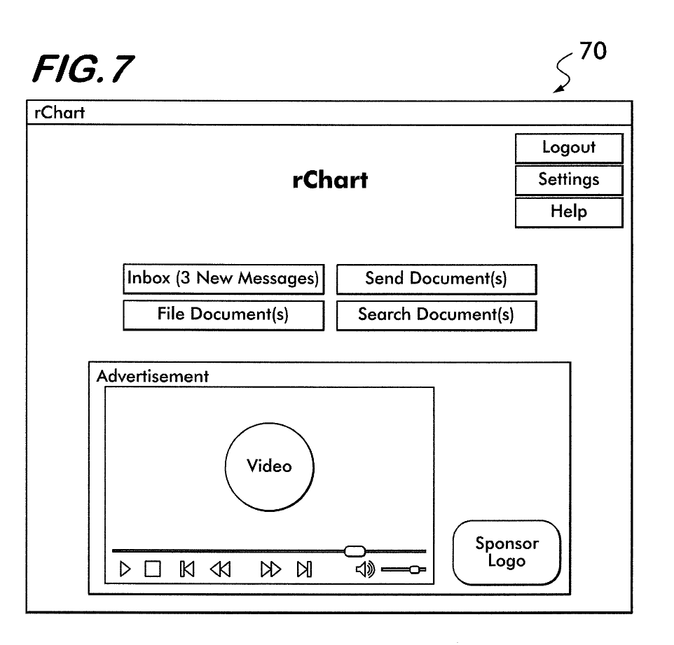

Referring now to FIG. 7, there is shown the clinician home page 70. The clinician home page 70 can be the starting point page or main page seen by clinicians when they enter the medical document advertising and media delivery system 10. The clinician home page can be a starting point for activities conducted by medical professionals in the rChart program. The clinician home page is intended to be very simple so that new clinician users can quickly and intuitively understand what their options for using the program are.

A clinician inbox can be provided for creating a secure messaging center similar to an email inbox. Note however that the rChart messages can be secure and internal to the rChart program in the preferred embodiment of the invention. They can be secured by encryption of any other known method. The clinician inbox can be integrated with a workflow engine and a rules engine that help to streamline the document sharing process. When a patient or a clinician indicates a desire to send a document (i.e. medical record) to a clinician, a message can appear in the inbox of the receiving clinician indicating that he or she is the recipient of a new document. The receiving clinician can then have the option to accept the sent document or reject it. The inbox can also be used for general purpose secure messaging between physicians, nurses, staff members, other clinicians and patients.

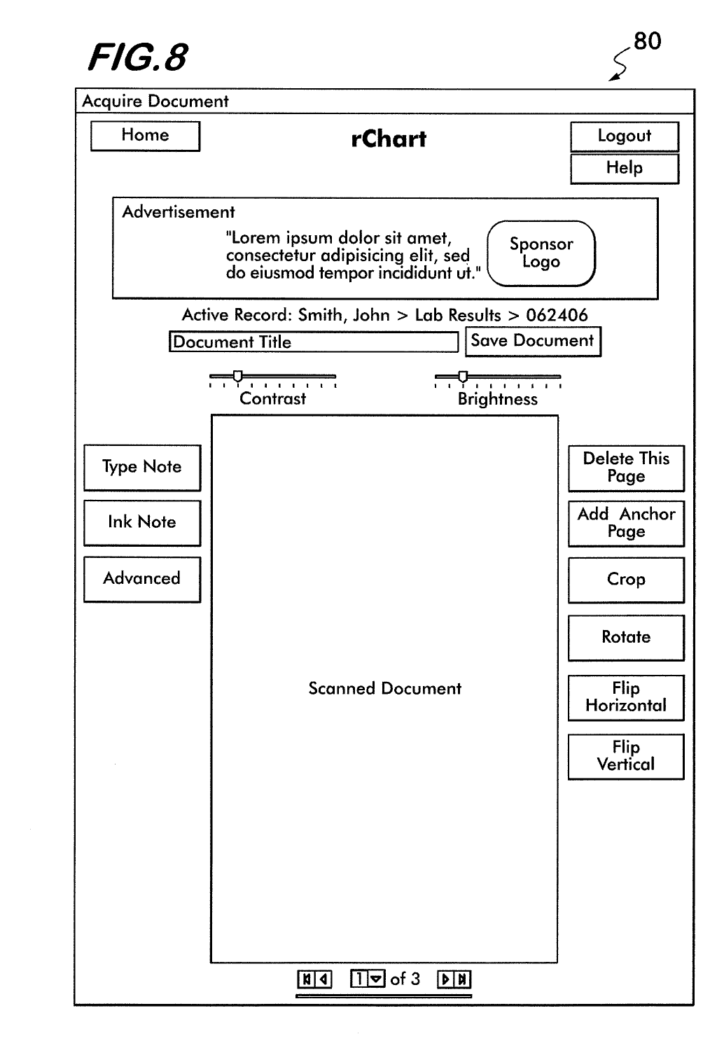

Referring now to FIG. 8, there is shown the scan screen 80. The scan screen 80 can be presented when a clinician or patient scans a document into rChart using any off-the-shelf scanner. The scan screen 80 is preferably simple (so intuitiveness is optimized). Basic document manipulation functions can be available on the scan screen 80 (i.e. contrast, brightness, crop, rotate, flip, delete page, add page, etc.). Additionally, a user can modify the scanned document by typing or inking (with a digital pen or mouse) directly on the scanned document. In the scan screen 80 a user can also add META data to the document by clicking the advanced button. META data can include indexed, searchable fields such as author, creation date, document type, keywords/tags, etc. Additionally, the user can name the scanned document and press the save button to upload the scanned document to rChart. Upon successful upload to rChart, the document can be passed through an optical character recognition engine (OCR) or a handwriting recognition engine and the resulting text can be stored with the document on the server for full-text searching.

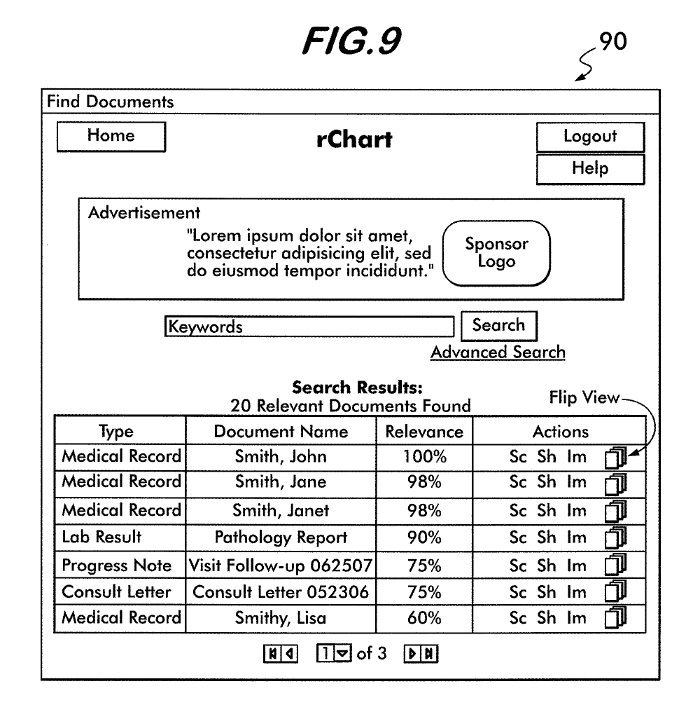

Referring now to FIG. 9, there is shown the search screen 90. The search screen 90 allows a user to search through documents that exist in their personal repository as well as shared documents stored in the patient's repository and the patient's other clinicians' repositories or other locations. Documents can be searched against the META data attached to the documents as well as the full text OCR and handwriting recognition text that is attached to the document. The search screen 90 can present a user with a list of matching document sorted by relevance to the search terms. The search screen 90 can have a list of enumerated actions that the user can select (i.e. modify, scan, send, import, flip view, etc.). An advanced search link available can also be presented for providing more complex search types. The search screen 90 can also provide location information along with the search results to allow the user to determine the location of any located documents that can be viewed. The documents that are shared in other rChart repositories can be requested using the search screen 90 in a preferred embodiment of the invention.

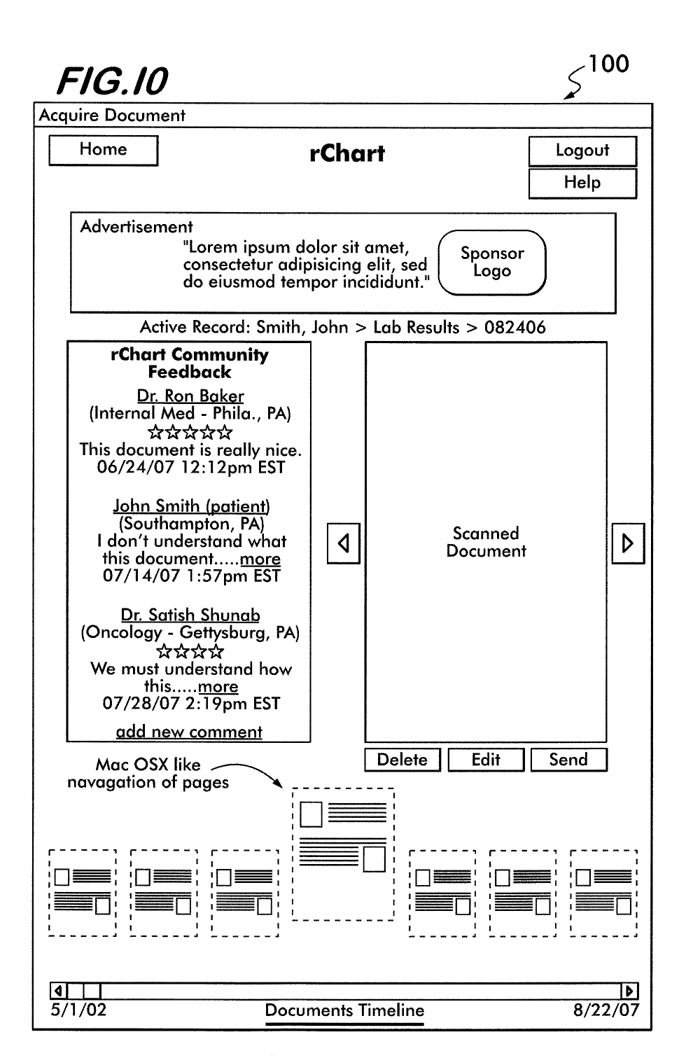

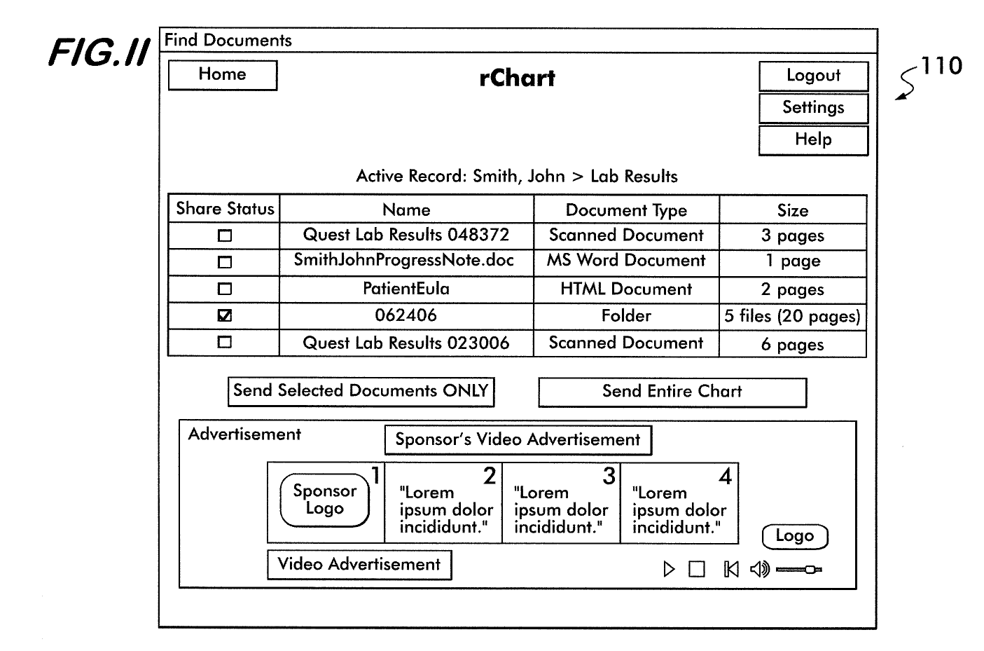

Referring now to FIG. 10, there is shown the flip view screen 100. The flip view screen 100 can be the main document viewing user interface for viewing documents within a scanned document region of the flip view screen 100. The flip view screen 100 can allow a user to quickly and easily flip though the documents in a particular folder. For example, the flip view screen 100 can allow rChart users to use finger gestures on a touch screen, or a mouse if no touch screen is available, to quickly move through the numerous pages that can be stored in a particular chart. On the bottom of the flip view screen 100 a sequence of thumbnails of documents that are in the current chart can be displayed. The user can view any one of the documents represented by a thumbnail by clicking on it. The interface provided by the flip view screen 100 should be very intuitive, with the intent being that it will be just as easy as flipping though a stack of papers. On the left of the flip view screen 100 is a community feedback area. rChart users can add comments to any document in the system 10 and view comments from any other user of the system 10. This community feedback area on the flip view screen 100 can allow clinicians and patients or users in other roles to collaborate on information in the patient's record and see comments on particular documents left by other users.

The medical document advertising and media delivery system 10 can also include an import screen for allowing users to drag-and-drop files directly into different regions of their rChart repository. Alternatively, users can upload files using a standard browse and upload web browser function. rChart can allow a user to store any type of file in the repository.

The medical record advertising system 10 can also include a send screen. The user can use the send screen when he or she decides which documents to send out of rChart. The send function can send a selected document or an entire chart to whichever person the user selects from an address book or other recipient source. The documents can be sent electronically, especially if the designated recipient is already a user of rChart.

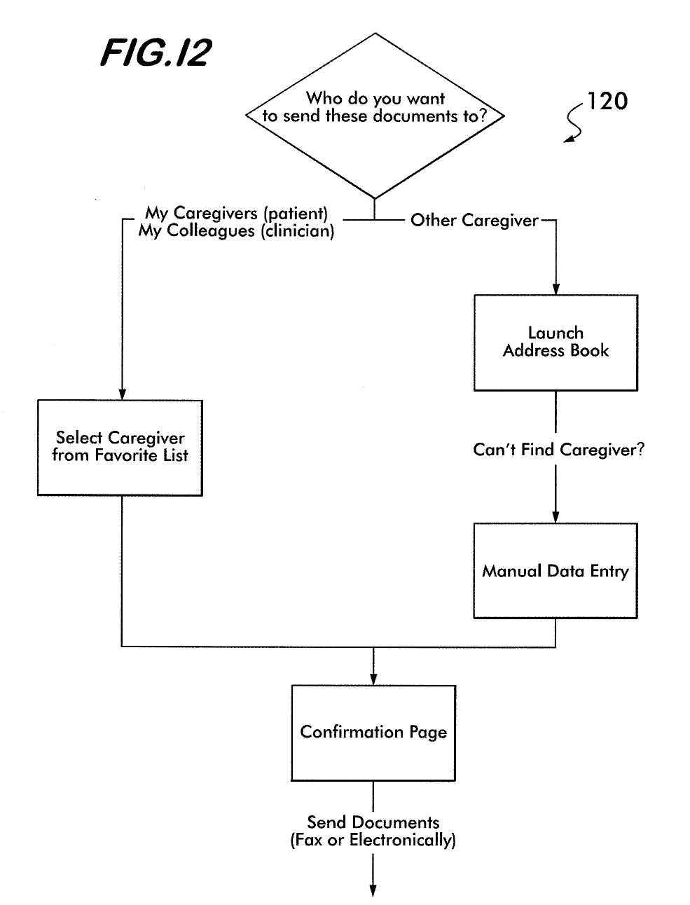

Referring now to FIG. 11, there is shown the share screen 110. The share screen 110 can be displayed by the medical document advertising and media delivery system 10 when the user wants to provide a shared chart with another party. The sharing wizard, which operates when the share screen 110 is displayed, allows the users to select the person to whom they wish to send the selected documents. The users can pick the recipient from a list of colleagues (clinician) or caregivers (patient). If the person receiving the documents is not in the list, the user can manually enter the name, address, phone number, and fax number of the party. Upon completing the sharing wizard workflow, the selected document can be sent via fax if the person is not a user of rChart or they will be sent electronically to an rChart member and a message can appear in that user's inbox.

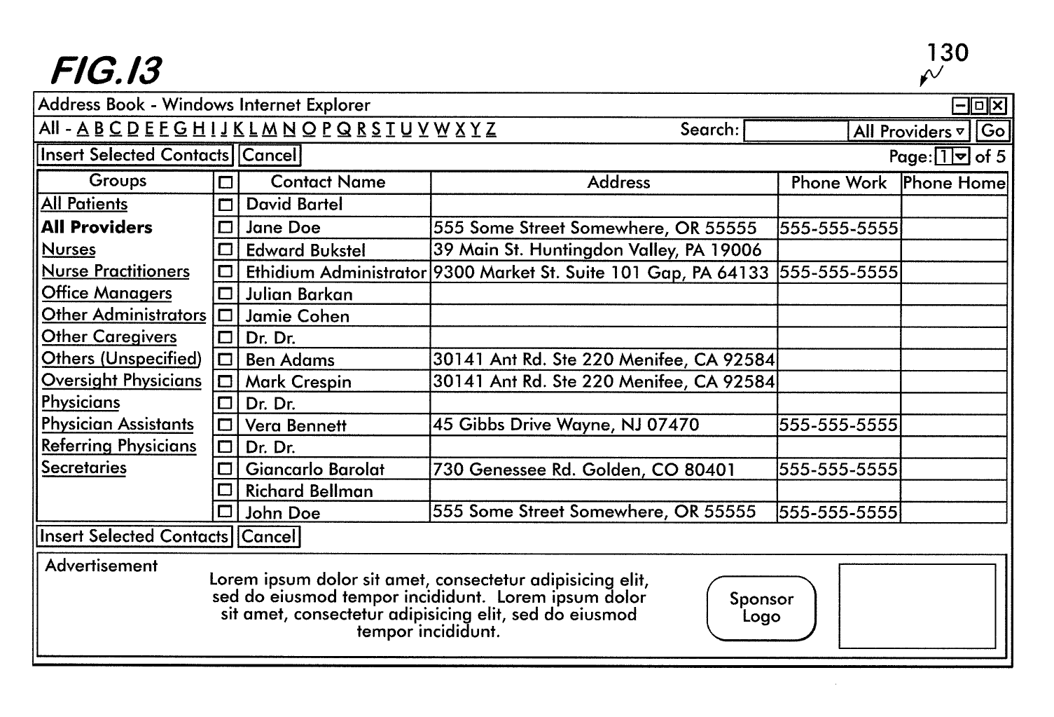

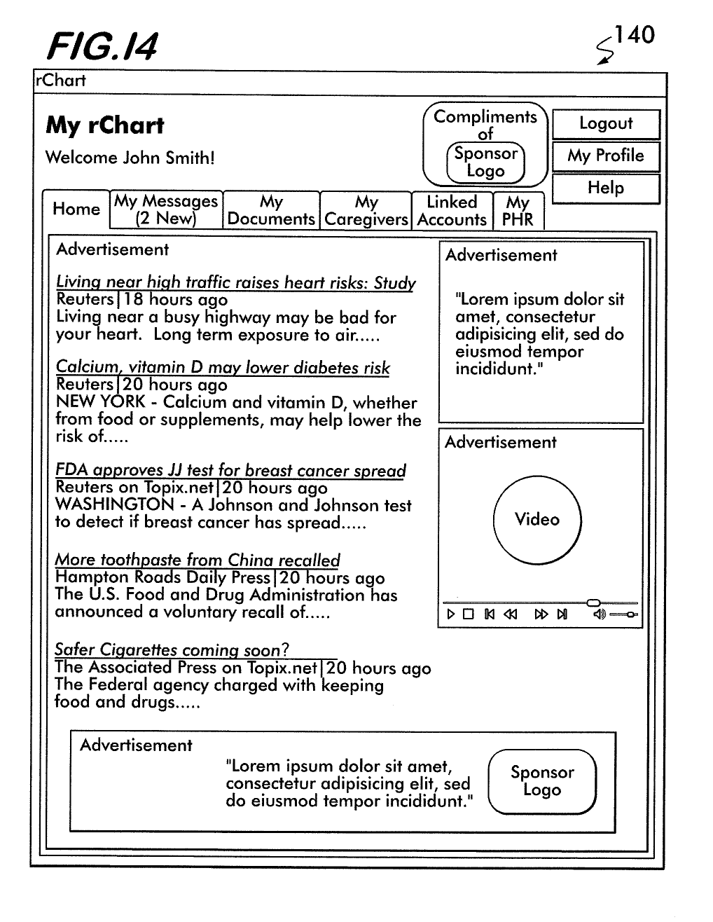

Referring now to FIGS. 12, 13, there is shown the share procedure 120 and the address book 130. The share procedure 120 can be used by a user of the medical record advertising system 10 while the share screen 120 is displayed and the sharing wizard is operating to share documents with other parties. In the share procedure 120 the user indicates the recipients of the documents. If the documents are to be sent to a caregiver by a patient, or to colleague by a clinician, a selection can be made from a favorites list. If the documents are to be sent to another recipient, the address book 130 can be launched. The address book 130 can include a list of all users of rChart. In one embodiment of the invention, the address book 130 can list all clinicians in the country, including clinicians that are not rChart users, so that they can still be selected for receiving rChart documents. If the recipient is not found in the address book 130 a manual data entry can be made by the user. In a preferred embodiment the user is provided with a confirmation page and the document is sent.

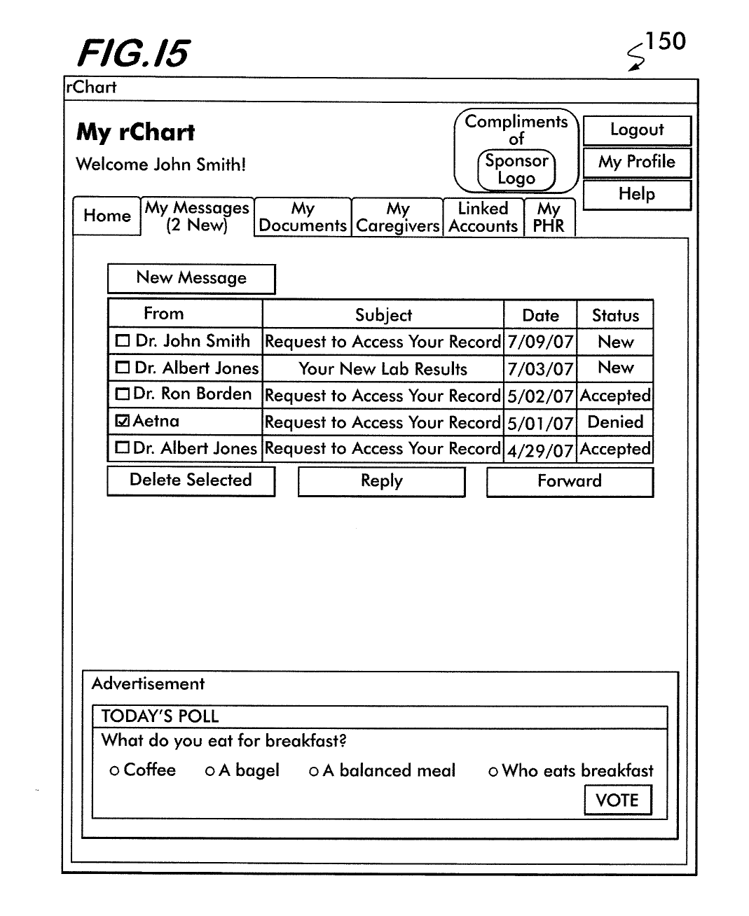

Referring now to FIG. 14, there is shown the patient home page 140. The patient home page 140 can be the first screen a patient sees upon logging-in to rChart. The patient home page 140 can be just a web news portal which has health related content and advertisements. The thinking behind the patient home page 140 can be that it can be a splash screen to show marquee ads. News or other items of potential interest to the patient can be offered to ensure a good reception of the patient home page 140 by the patient.

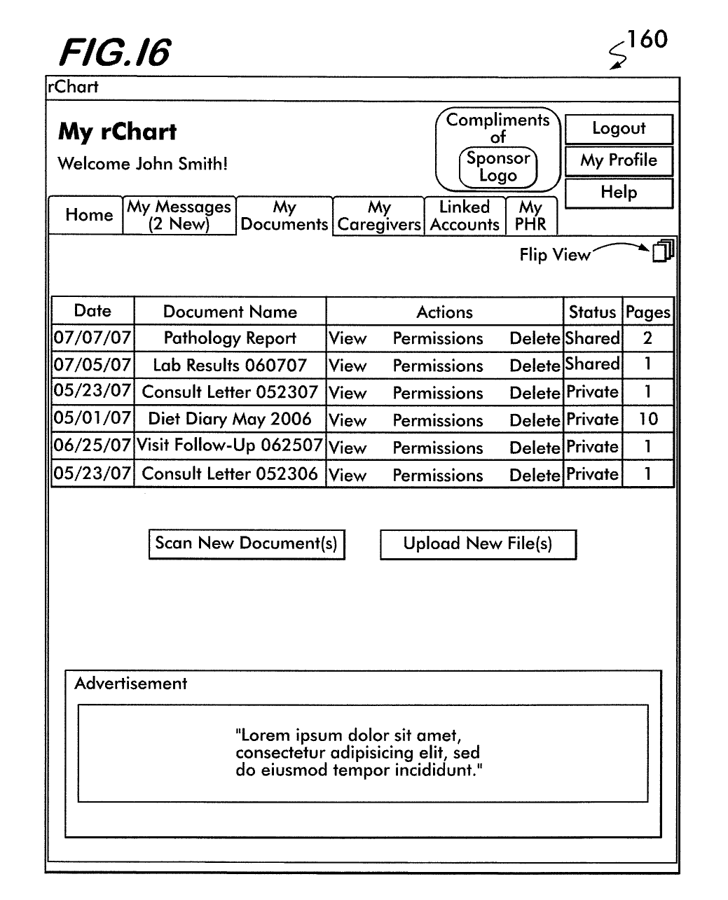

Referring now to FIG. 15, a patient messages inbox 150 can be provided for receiving and displaying patient messages. The patient messages inbox 150 can be accessed by clicking on a My Messages tab provided on the patient messages inbox 140. Requests for access to the patient's medical records can arrive in the patient's messages inbox 150. The patient messages inbox 150 can be similar to an email inbox and can permit the patient to reply to the messages, allow access to their documents, etc. In addition to chat access request, standard secure, patient-clinician messaging can also be conducted through the patient messages inbox 150.

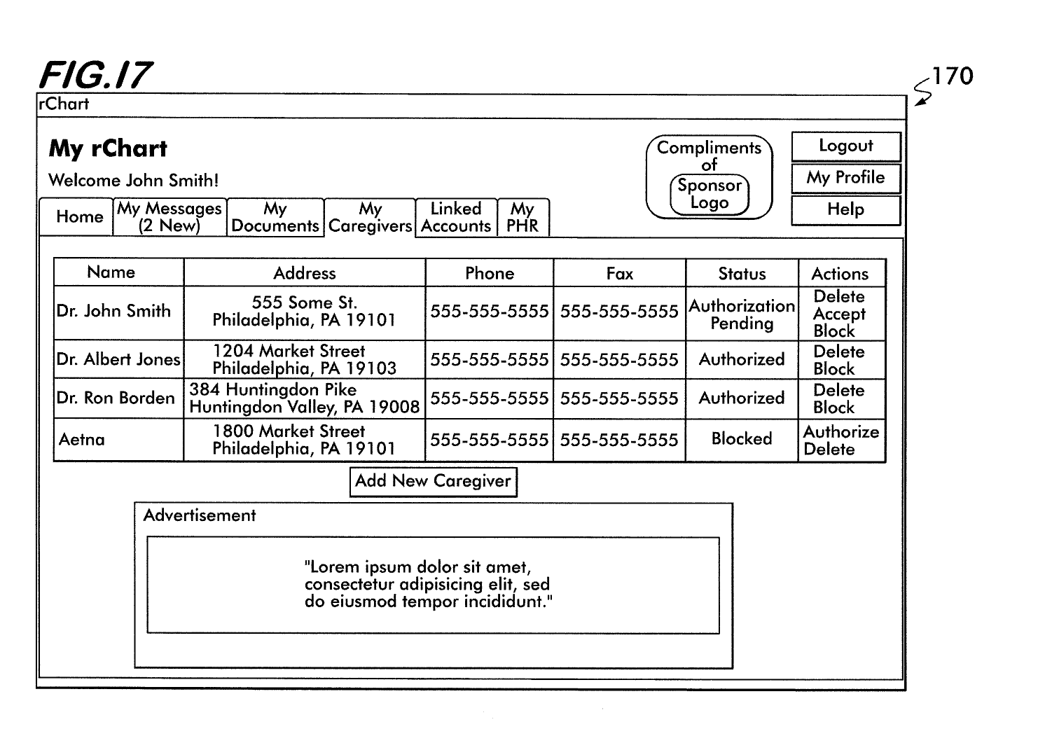

Referring now to FIG. 16, a patient document screen 160 can be provided for permitting the patient access and control of patient documents as previously described. The patient document screen 160 can be accessed by clicking on a My Documents tab provided on the patient home page 140. The patient document screen 160 can display a list of every document that the patient has stored in his/her rChart repository. Additionally, the patient document screen 160 can provide all information associated with each stored document as well as procedures for performing all permitted types of control of the documents.

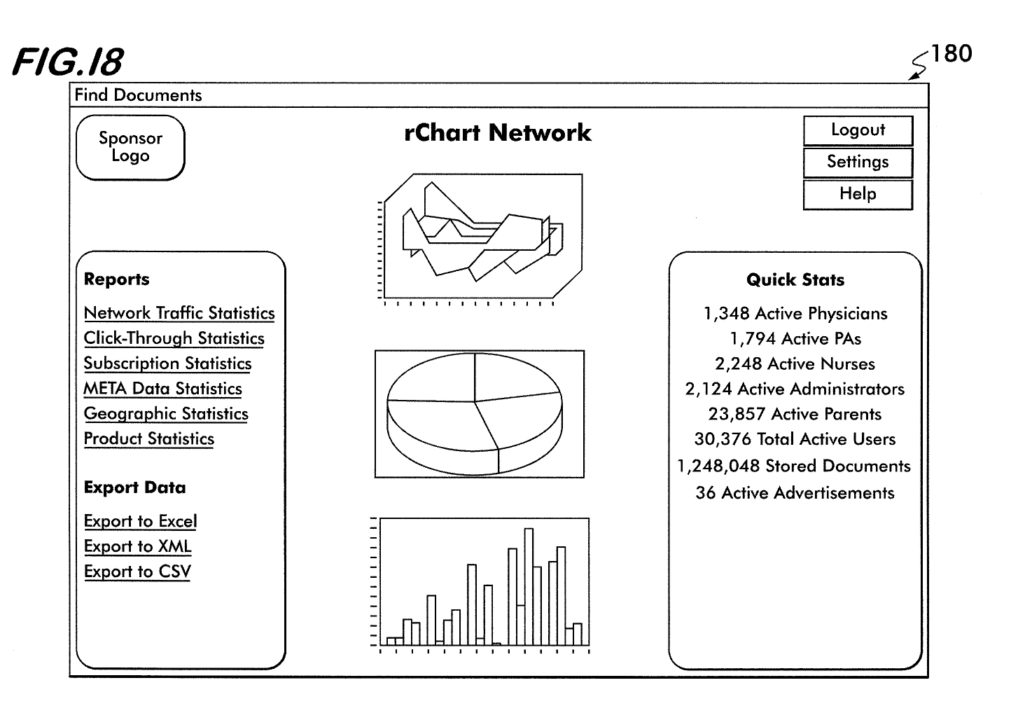

Referring now to FIG. 17, a patient caregiver screen 170 can be provided for displaying contact information for the caregivers being used by a patient. The patient caregiver screen 170 can be accessed by clicking on a My Caregivers tab provided on the patient home page 140. Additionally, the patient caregiver screen 170 can provide all information associated with each caregiver that may be useful to the patient.

Referring now to FIG. 18, there is shown the sponsor home page 180. The sponsor home page 180 is a page within the medical record advertising system 10 where sponsors can be directed when they login to rChart. Furthermore, the sponsor home page 180 can be used by sponsors within the medical record advertising system 10 to perform operations such as generating reports and analyzing aspects of the rChart network. The sponsor home page 180 can also be used by sponsors to manage their ads and placements within rChart.

Each screen location within rChart that can support an advertisement can be called a placement. Each placement within rChart can have a particular size (width×height) and capability (text only, video, news, etc.). The operators of the medical document advertising and media delivery system 10 can thus maintain a database of placements that can allow sponsors to appropriately place their advertisements based on their needs and placement capabilities. Furthermore, the advertisements within the medical record advertising system 10 do not necessarily need to be banner ads, or Google-like text ads. Advertisements can be any kind of text, articles (i.e. continuing medical education, news, etc.), video, audio, etc.

While the invention has been described in detail and with reference to specific examples thereof, it will be apparent to one skilled in the art that various changes and modifications can be made therein without departing from the spirit and scope thereof.

What is claimed is:

1. A method for displaying and distributing provided data including media and advertisements to a user of an electronic system for management of medical documents, said method comprising:
(a) establishing and operating a web-based application for viewing, storing, managing and sharing said medical documents in electronic format by an operator;
(b) providing said provided data;
(c) selecting at least portions of said provided data based upon sponsorship by a sponsoring entity to provide selected data, said provided data being correlated to stored profile attributes of said user;
(d) displaying and distributing said selected data; and
(e) said sponsoring entity providing compensation to said operator.

2. The method for displaying and distributing media and advertisements of claim 1, wherein said step of selecting said selected data results in the selection of a default entity as a sponsoring entity or the operator in the absence of any sponsoring entity.

3. The method for displaying and distributing media and advertisements of claim 1, wherein said sponsorship comprises sponsorship of a single user by a plurality of entities.

4. The method for displaying and distributing media and advertisements of claim 1, wherein said medical documentation and related documents comprise scanned images.

5. The method for displaying and distributing media and advertisements of claim 1, wherein said medical documentation and related documents are digital files uploaded by said user.

6. The method for displaying and distributing media and advertisements of claim 1, wherein said medical documentation and related documents comprise data entered manually by said user.
